(19) United States
(12) Patent Application Publication
(10) Pub. No.: US 2008/0319155 A1
(43) Pub. Date: Dec. 25, 2008

(54) OPTOELECTRONIC POLYMER COMPOSITIONS, AND DEVICES THEREFROM

(75) Inventors: Jie Liu, Niskayuna, NY (US); Yanshi Zhang, Schenectady, NY (US); Qing Ye, Schenectady, NY (US); James Anthony Cella, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/766,424

(22) Filed: Jun. 21, 2007

(51) Int. Cl. C08G 14/04

(52) U.S. Cl. 528/125

(57) ABSTRACT

In one aspect, the invention provides a polyarylether having pendant carbazolyl groups. The polymers of the invention are made by the bromination of a polyarylether, which is then reacted with a carbazole moiety. The polymers may have some amount of unsubstituted aromatic groups and some brominated aromatic groups also. These polymers find use in optoelectronic device. Thus, in another aspect, the invention provides optoelectronic device comprising a polyarylether having pendant carbazolyl groups.

### BACKGROUND

The invention relates generally to polyarylether compositions that comprise pendant carbazolyl groups. The invention also relates to optoelectronic device comprising polyarylether compositions of the invention.

Optoelectronic devices, which make use of thin film materials that emit light when subjected to a voltage bias, are expected to become an increasingly popular form of flat panel display technology. This is because optoelectronic devices have a wide variety of potential applications, including cellphones, personal digital assistants (PDAs), computer displays, information displays in vehicles, television monitors, as well as light sources for general illumination. Due to their bright colors, wide viewing angle, compatibility with full motion video, broad temperature ranges, thin and conformable form factor, low power requirements and the potential for low cost manufacturing processes, optoelectronic devices are seen as a future replacement technology for cathode ray tubes (CRTs) and liquid crystal displays (LCDs). Due to their high luminous efficiencies, optoelectronic devices are seen as having the potential to replace incandescent, and perhaps even fluorescent, lamps for certain types of applications.

One approach to achieve full-color optoelectronic devices includes energy transfer from host to emissive guest molecules. For this to be realized, the triplet energy state of the host has to be higher than the guest molecule. Carbazole derivatives have shown promise to perform well as host molecule in the presence of metal containing emissive guest molecules. Often used in this respect is poly(N-vinyl carbazole) (PVK). But PVK is not an ideal host candidate since its triplet energy gap is about 2.5 eV. Iridium (III) bis(4,6-difluorophenyl pyridinato-N,C²-picolinato) (FIrpic) is a blue phosphorescent dye which when used in OLEDs exhibits high quantum efficiency. The triplet energy gap for FIrpic is 2.7 eV which is greater than the triplet energy gap for PVK, resulting in reduced quantum efficiency in the devices. Thus, there is a need in the art to develop optoelectronic devices having polymers with high triplet energy gaps, while still maintaining the potential for the molecules to host red, green, and blue emissive complexes.

### BRIEF DESCRIPTION

In one aspect, the invention provides a polyarylether comprising structural units of formula I

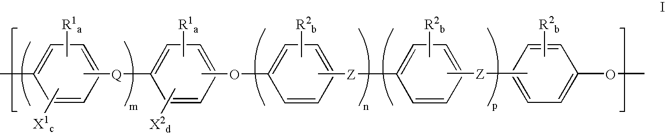

wherein
X¹ and X² are independently selected from Br, H,

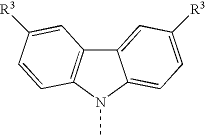

and combinations thereof;
R¹ and R² are independently at each occurrence H, halo, cyano, nitro, a C₁-C₁₂ aliphatic radical, a C₃-C₁₂ cycloaliphatic radical, a C₃-C₁₂ aromatic radical or a combination thereof;
R³ is hydrogen, triarylsilyl, trialkylsilyl, mesityl, t-butyl, diphenyl phosphine oxide, and diphenyl phosphine sulfide;
Q is a direct bond, O, S, alkenyl, alkynyl, a C₁-C₁₂ aliphatic radical, a C₃-C₁₂ cycloaliphatic radical, a C₃-C₁₂ aromatic radical or a combination thereof;
Z is a direct bond, O, S, SO, SO₂, CO, phenylphospinyl oxide, alkenyl, alkynyl, a C₁-C₁₂ aliphatic radical, a C₃-C₁₂ cycloaliphatic radical, a C₃-C₁₂ aromatic radical or a combination thereof;
a and b are independently 0, 1 or 2;
c and d independently range from about 0.5 to about 3;
m, n and p are independently 0 or 1; and
at least one of X¹ and X² is

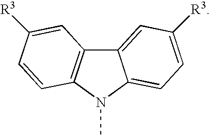

In another aspect, the invention provides an optoelectronic device comprising at least one emissive layer wherein the light emissive layer comprises a polyarylether comprising structural units of formula I.

### DRAWINGS

These and other features, aspects, and advantages of the present invention will become better understood when the following detailed description is read with reference to the accompanying drawings in which like characters represent like parts throughout the drawings, wherein:

FIG. 1 shows the triplet energy levels of a sample containing a polymer of the invention and a sample containing a dye in a polystyrene matrix,

FIG. 2 shows an electroluminescence spectrum for a device that comprises a polymer of the invention,

FIG. 3 shows a plot of external quantum efficiency (%) versus current density (mA/cm²) for a device that comprises a polymer of the invention.

### DETAILED DESCRIPTION

In one embodiment, the invention provides a polyarylether comprising structural units of formula I, which comprise pendant carbazolyl groups and are generally made by a post polymerization modification reaction of a polyarylether.

Polyarylethers useful in the invention include other functional groups such as, but not limited to, sulfones, ketones, sulfoxides, imides, and the like. The polyarylethers are generally made by the nucleophilic displacement condensation reaction between bisphenols and dihalogenated monomers. Bisphenols useful here include, but are not limited to, resorcinol; catechol; hydroquinone; 1,2-dihydroxy naphthalene; 1,4-dihydroxy naphthalene; 1,3-dihydroxy naphthalene; 2,6-dihydroxy naphthalene; 2,7-dihydroxynapthalene; bis(4-hydroxyphenyl)-1,4-diisopropylbenzene; bis(4-hydroxyphenyl)-1,3-diisopropylbenzene; 4,4′-dihydroxyphenyl sulfone; 2,4′-dihydroxyphenyl sulfone; 4,4′-dihydroxyphenyl sulfoxide; 2,4′-dihydroxyphenyl sulfoxide; 2-diphenylphosphinylhydroquinone; bis(2,6-dimethylphenol) 2,2′-biphenol; 4,4-biphenol; 4,4′-bis(3,5-dimethyl)biphenol; 4,4′-bis(2,3,5-trimethyl)biphenol; 4,4′-bis(2,3,5,6-tetramethyl)biphenol; 4,4′-bis(3,5-dibromo-2,6-dimethyl)biphenol; 4,4′-bis(3-bromo-2,6-dimethyl)biphenol; 4,4′-isopropylidenediphenol (bisphenol A); 4,4′-isopropylidenebis(2,6-dibromophenol) (tetrabromobisphenol A); and the like. The dihalogenated monomers useful in the invention include, but not limited to, 4,4′-dichlorodiphenylsulfone; 2,4′-dichlorodiphenylsulfone; 2,2′-dichlorodiphenylsulfone; 2,2-dichlorodiphenylsulfone; 2,4-dichlorodiphenylsulfone; 4,4′-difluorodiphenylsulfone; 2,4′-difluorodiphenylsulfone; 2,2′-difluorodiphenylsulfone; 2,2-difluorodiphenylsulfone; 2,4-difluorodiphenylsulfone; 2,4-dichlorobenzonitrile, 4,4′-difluorobenzophenol; 4,4′-dichlorobenzophenols; 4,4′-dichlorobenzophenone; 4,4′-difluorobenzophenone and the like.

The reaction is typically conducted in a solvent in the presence of a base. Bases useful for this reaction includes, but is not limited to, potassium carbonate, potassium bicarbonate, sodium carbonate, sodium bicarbonate, sodium alkoxylates, potassium alkoxylates, potassium phosphate, and the like, and combinations thereof. Solvents useful in the reaction include, but not limited to, orthodichlorobenzene, anisole, veratrole, toluene, chlorobenzene, and the like, and combinations thereof.

The reaction may be conducted at a temperature ranging from about 50° C. to about 300° C., and for a time period ranging from about 2 hours to about 48 hours. Typically, the polymerization reaction is conducted at a temperature and for a time period necessary to achieve polymer of a suitable molecular weight.

Polyarylethers useful in the invention are characterized by average molecular weights. The molecular weight of a polymer is determined by any of the techniques known to those skilled in the art, and include viscosity measurements, light scattering, osmometry, and the like. The molecular weight of a polymer is typically represented as a number average molecular weight Mₙ, or weight average molecular weight, M_{w}. A particularly useful technique to determine molecular weight averages is gel permeation chromatography (GPC), from wherein both number average and weight average molecular weights are obtained. In some embodiments, it is desirable that M_{w} of the polymer ranges from about 10,000 grams per mole (g/mol) to about 100,000 g/mol. M_{w} is determined using polystyrene as standard.

In some embodiments, the polyarylether useful in the invention is a polyarylethersulfone. Polyarylethersulfones may be synthesized by following the procedures described herein. In one particular embodiment, the polyarylether is made by the reaction between bisphenol A and dihalodiphenyl sulfone, such as 4,4′-dichlorodiphenyl sulfone. Alternately, polyarylethersulfones are available commercially from, for example, Solvay Advanced Polymers, Henrietta, Ga., under the tradename of Udel®, Radel® and the like.

As noted, polyarylethers of the invention further comprise pendant carbazolyl groups having formula

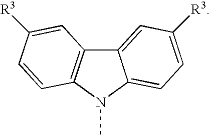

Polyarylethers comprising structural units of formula I may be synthesized by a post polymerization modification reaction of the polyarylether. In one embodiment, the modification involves a multi-step process that includes a first step of electrophilic aromatic substitution with a suitable halogen, typically bromine, followed by a nucleophilic aromatic substitution with a carbazole compound. The aromatic substitution reactions may be facilitated by the use of suitable catalysts in the presence of inert solvents. For example, the nucleophilic aromatic substitution is facilitated by the use of bases. The reactions are conducted at a temperature ranging from about 20° C. to about 200° C. The reactions are allowed to proceed for a time period ranging from about 1 hour to about 48 hours.

One skilled in the art would readily understand that the number of carbazole-substituted repeat units and the number of carbazole groups per repeat unit depend on the nature of reaction parameters, such as number moles of carbazole reactant with respect to the number of moles of repeat unit, number of moles of halogen substituted aromatic ring, number of halogen groups per repeat unit, time, temperature, solvent, and so on. Other factors such as steric hindrances may also contribute to the number of carbazole groups per repeat unit. Typically, a distribution of carbazole-substituted repeat units is achieved that may range from about 0.5 to about 3.

In one specific embodiment, Q is C(CH₃)₂ and Z is SO₂ and the polyarylether of the invention has structure

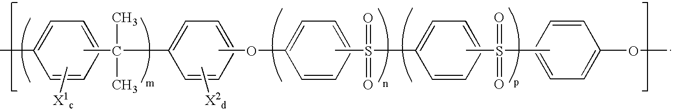

The X¹ and X² have structure

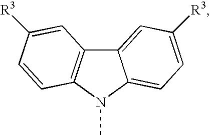

and is generally made by the reaction of a carbazole that is substituted at the 3 and 6 position with an R³ group. Typical R³ groups useful in the invention include, but not limited to, triarylsilyl, trialkylsilyl, t-butyl, mesityl, diphenyl phosphine oxide, and diphenyl phosphine sulfide. In some embodiments, the X¹ and X² have structure

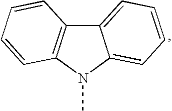

and is derived from an unsubstituted carbazole.

One skilled in the art will also appreciate that the polymer of the invention may have some halogen groups from the electrophilic substitution reaction that did not undergo the nucleophilic substitution reaction with the carbazole reactant. The extent of halogenation of aromatic rings on the repeat units as opposed to carbazole-substituted aromatic rings on the repeat units depends on various reaction parameters. Thus, in one embodiment, the polyarylethers of the invention comprise aromatic rings having halogen substituents and aromatic rings having carbazole substituents.

One skilled in the art would also appreciate that after the reaction of the polyarylether with a halogen and subsequently with a carbazole, some repeat units that are unsubstituted with either halogen or carbazole compound may still be present. Thus, the polyarylether of the invention further comprise structural units of formula

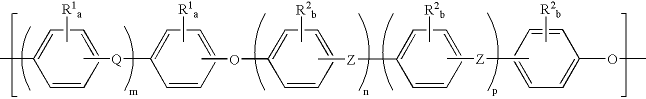

wherein R¹, R², Q, Z, a, b, m, n and p are all as defined.

In another specific embodiment, the polyarylether of the invention is a polyarylethersulfone, wherein Q is C(CH₃)₂ and Z is SO₂ and the unreacted structural units comprise structural units of formula

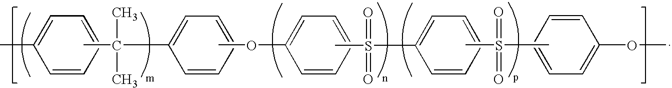

In one particular embodiment, the polymer of the invention is derived from bisphenol A and dichlorodiphenylsulfone having two unsubstituted carbazole pendant groups on the 2,2′-positions of the bisphenol A part of the repeat unit, and comprises structural units of formula

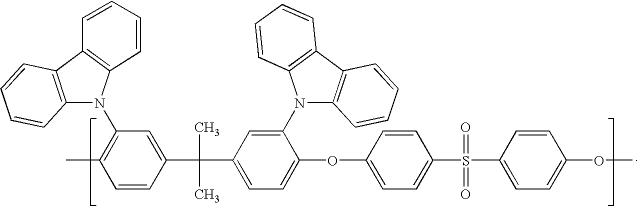

Polymers provided in the present invention may find use in a wide variety of applications that include, but are not limited to, light emitting electrochemical cells, photo detectors, photo conductive cells, photo switches, display devices and the like. Thus, in one aspect, the invention provides a light emitting device comprising at least one electrode, at least one hole injection layer, at least one light emissive layer; wherein the light emissive layer comprises a polymer having structural units of formula I. In another aspect, the invention provides a light emitting device comprising at least one electrode, at least one hole injection layer, at least one light emissive layer; wherein the light emissive layer comprises a polymer having structural units of formula I.

The polymers provided in the present invention are particularly well suited for use in electroactive layers in optoelectronic devices. In one embodiment, the present invention provides an optoelectronic device comprising an electroactive layer, which consists essentially of a polymer of the invention. In another embodiment, the present invention provides an optoelectronic device comprising the polymer of the invention as a constituent of an electroactive layer of an optoelectronic device. In one embodiment, the present invention provides an optoelectronic device comprising the polymer of the invention as a constituent of a light emitting electroactive layer of an optoelectronic device.

An optoelectronic device typically comprises multiple layers which include in the simplest case, an anode layer and a corresponding cathode layer with an organic electrophosphorescent layer disposed between said anode and said cathode. When a voltage bias is applied across the electrodes, electrons are injected from the cathode into the electrophosphorescent layer while electrons are removed from (or “holes” are “injected” into) the electroluminescent layer from the anode. Light emission occurs as holes combine with electrons within the electrophosphorescent layer to form singlet or triplet excitons, light emission occurring as singlet excitons transfer energy to the environment by radiative decay.

Other components which may be present in an optoelectronic device in addition to the anode, cathode, and light emitting material include hole injection layers, electron injection layers, and electron transport layers. The electron transport layer need not be in contact with the cathode, and frequently the electron transport layer is not an efficient hole transporter and thus it serves to block holes migrating toward the cathode. During operation of an optoelectronic device comprising an electron transport layer, the majority of charge carriers (i.e. holes and electrons) present in the electron transport layer are electrons and light emission can occur through recombination of holes and electrons present in the electron transport layer. Additional components which may be present in an optoelectronic device include hole transport layers, hole transporting emission (emitting) layers and electron transporting emission (emitting) layers.

Polymers comprising structural units of formula I have triplet energy states that are useful in applications such as optoelectronic devices, as they may give rise to highly efficient devices. Further, the triplet energy of these polymers may be high enough that it may be greater than those of the phosphorescent dyes used in devices, and thus may serve as host molecules.

The organic electroluminescent layer is a layer within an optoelectronic device which when in operation contains a significant concentration of both electrons and holes and provides sites for exciton formation and light emission. A hole injection layer is a layer in contact with the anode which promotes the injection of holes from the anode into the interior layers of the optoelectronic device; and an electron injection layer is a layer in contact with the cathode that promotes the injection of electrons from the cathode into the optoelectronic device; an electron transport layer is a layer which facilitates conduction of electrons from cathode to a charge recombination site. The electron transport layer need not be in contact with the cathode, and frequently the electron transport layer is not an efficient hole transporter and thus it serves to block holes migrating toward the cathode. During operation of an optoelectronic device comprising an electron transport layer, the majority of charge carriers (i.e. holes and electrons) present in the electron transport layer are electrons and light emission can occur through recombination of holes and electrons present in the electron transport layer. A hole transport layer is a layer which when the optoelectronic device is in operation facilitates conduction of holes from the anode to charge recombination sites and which need not be in contact with the anode. A hole transporting emission layer is a layer in which when the optoelectronic device is in operation facilitates the conduction of holes to charge recombination sites, and in which the majority of charge carriers are holes, and in which emission occurs not only through recombination with residual electrons, but also through the transfer of energy from a charge recombination zone elsewhere in the device. An electron transporting emission layer is a layer in which when the optoelectronic device is in operation facilitates the conduction of electrons to charge recombination sites, and in which the majority of charge carriers are electrons, and in which emission occurs not only through recombination with residual holes, but also through the transfer of energy from a charge recombination zone elsewhere in the device.

Materials suitable for use as the anode include materials having a bulk conductivity of at least about 100 ohms per square, as measured by a four-point probe technique. Indium tin oxide (ITO) is frequently used as the anode because it is substantially transparent to light transmission and thus facilitates the escape of light emitted from electro-active organic layer. Other materials which may be utilized as the anode layer include tin oxide, indium oxide, zinc oxide, indium zinc oxide, zinc indium tin oxide, antimony oxide, and mixtures thereof.

Materials suitable for use as the cathode include by zero valent metals which can inject negative charge carriers (electrons) into the inner layer(s) of the OLED. Various zero valent metals suitable for use as the cathode include K, Li, Na, Cs, Mg, Ca, Sr, Ba, Al, Ag, Au, In, Sn, Zn, Zr, Sc, Y, elements of the lanthanide series, alloys thereof, and mixtures thereof. Suitable alloy materials for use as the cathode layer include Ag—Mg, Al—Li, In—Mg, Al—Ca, and Al—Au alloys. Layered non-alloy structures may also be employed in the cathode, such as a thin layer of a metal such as calcium, or a metal fluoride, such as LiF, covered by a thicker layer of a zero valent metal, such as aluminum or silver. In particular, the cathode may be composed of a single zero valent metal, and especially of aluminum metal.

Materials suitable for use in hole transporting layers include 1,1-bis((di-4-tolylamino)phenyl)cyclohexane, N,N′-bis(4-methylphenyl)-N,N′-bis(4-ethylphenyl)-(1,1′-(3,3′-dimethyl)biphenyl)-4,4′-diamine, tetrakis-(3-methylphenyl)-N,N,N′,N′-2,5-phenylenediamine, phenyl-4-N,N-diphenylaminostyrene, p-(diethylamino) benzaldehyde diphenylhydrazone, triphenylamine, 1-phenyl-3-(p-(diethylamino)styryl)-5-(p-(diethylamino)phenyl)pyrazoline, 1,2-trans-bis(9H-carbazol-9-yl)cyclobutane, N,N,N′,N′-tetrakis(4-methylphenyl)-(1,1′-biphenyl)-4,4′-diamine, copper phthalocyanine, polyvinylcarbazole, (phenylmethyl)polysilane; poly(3,4-ethylendioxythiophene) (PEDOT), polyaniline, polyvinylcarbazole, triaryldiamine, tetraphenyldiamine, aromatic tertiary amines, hydrazone derivatives, carbazole derivatives, triazole derivatives, imidazole derivatives, oxadiazole derivatives having an amino group, and polythiophenes as disclosed in U.S. Pat. No. 6,023,371.

Materials suitable for use as the electron transport layer include poly(9,9-dioctyl fluorene), tris(8-hydroxyquinolato) aluminum (Alq₃), 2,9-dimethyl-4,7-diphenyl-1,1-phenanthroline, 4,7-diphenyl-1,10-phenanthroline, 2-(4-biphenylyl)-5-(4-t-butylphenyl)-1,3,4-oxadiazole, 3-(4-biphenylyl)-4-phenyl-5-(4-t-butylphenyl)-1,2,4-triazole, 1,3,4-oxadiazole-containing polymers, 1,3,4-triazole-containing polymers, quinoxaline-containing polymers, and cyano-PPV.

### Definitions

In the context of the present invention, alkyl is intended to include linear, branched, or cyclic hydrocarbon structures and combinations thereof, including lower alkyl and higher alkyl. Preferred alkyl groups are those of C₂₀ or below. Lower alkyl refers to alkyl groups of from 1 to 6 carbon atoms, preferably from 1 to 4 carbon atoms, and includes methyl, ethyl, n-propyl, isopropyl, and n-, s- and t-butyl. Higher alkyl refers to alkyl groups having seven or more carbon atoms, preferably 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, and norbornyl. Alkenyl and alkynyl refer to alkyl groups wherein two or more hydrogen atoms are replaced by a double or triple bond, respectively.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0-3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen. Examples include methoxy, ethoxy, propoxy, isopropoxy, cyclopropyloxy, and cyclohexyloxy. Lower alkoxy refers to groups containing one to four carbons.

Acyl refers to groups of from 1 to 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include acetyl, benzoyl, propionyl, isobutyryl, t-butoxycarbonyl, and benzyloxycarbonyl. Lower-acyl refers to groups containing one to four carbons.

Heterocycle means a cycloalkyl or aryl residue in which one to three of the carbons is replaced by a heteroatom such as oxygen, nitrogen or sulfur. Examples of heterocycles that fall within the scope of the invention include pyrrolidine, pyrazole, pyrrole, indole, quinoline, isoquinoline, tetrahydroisoquinoline, benzofuran, benzodioxan, benzodioxole (commonly referred to as methylenedioxyphenyl, when occurring as a substituent), tetrazole, morpholine, thiazole, pyridine, pyridazine, pyrimidine, thiophene, furan, oxazole, oxazoline, isoxazole, dioxane, and tetrahydrofuran, triazole, benzotriazole, and triazine.

Substituted refers to structural units, including, but not limited to, alkyl, alkylaryl, aryl, arylalkyl, and heteroaryl, wherein up to three H atoms of the residue are replaced with lower alkyl, substituted alkyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy; each of said phenyl, benzyl, phenoxy, benzyloxy, heteroaryl, and heteroaryloxy is optionally substituted with 1-3 substituents selected from lower alkyl, alkenyl, alkynyl, halogen, hydroxy, haloalkyl, alkoxy, cyano, phenyl, benzyl, benzyloxy, carboxamido, heteroaryl, heteroaryloxy, nitro or —NRR (wherein R is independently H, lower alkyl or cycloalkyl, and —RR may be fused to form a cyclic ring with nitrogen).

Haloalkyl refers to an alkyl residue, wherein one or more H atoms are replaced by halogen atoms; the term haloalkyl includes perhaloalkyl. Examples of haloalkyl groups that fall within the scope of the invention include CH₂F, CHF₂, and CF₃.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

### Experimental

General: Molecular weight data was obtained using Perkin Elmer GPC Series 200 with UV/VIS Detector, Polymer Laboratories PLGel 5 mm column, chloroform as eluent, and polystyrene standards as the calibration standards. NMR spectroscopy was performed on Bruker 400 MHz instrument. Udel® polysulfone was obtained from Solvay Advanced Polymers, Henrietta, Ga. had a Mw of 60,000 and a polydispersity index of 3.2. A green phosphorescent dye, tris(2-(4-tolyl)phenylpyridine)iridium Ir(mppy)₃ was purchased from American Dye Sources, Canada and used as received. Glass pre-coated with indium tin oxide (ITO) was obtained from Applied Films. Poly(3,4-ethylendioxythiophene)/poly-styrene sulfonate (PEDOT:PSS) was purchased from H.C. Starck Co., GmbH, Leverkusen, Germany. N,N′-diphenyl-N—N″-(bis(3-methylphenyl)-(1,1-biphenyl)-4-4′-diamine (TPD) and 2-(4-biphenyllyl)-5-(4-tert-butylphenyl)-1,3,4-oxadiazole (PBD) was used as a hole injection material and an electron injection material, respectively. Both TPD and PBD were purchased from Aldrich and used as received.

Polysulfones having carbazole pendant groups may be prepared in a facile manner by brominating the polysulfone, followed by reacting with carbazole, using the procedure described by Klapars et al. in J. Am. Chem. Soc., 123, 7727-7729 (2001). The sequence of reactions is shown in Scheme 1. The reaction of carbazole with brominated polysulfone can be effected using about 10 mole % of copper iodide. A diamino compound, which can be chosen from a pool of potential candidates, may be used as a ligand to accelerate this reaction. K₃PO₄ may act as the base to effect the reaction. Using dioxane as the solvent, the reaction may be completed in 24 hours.

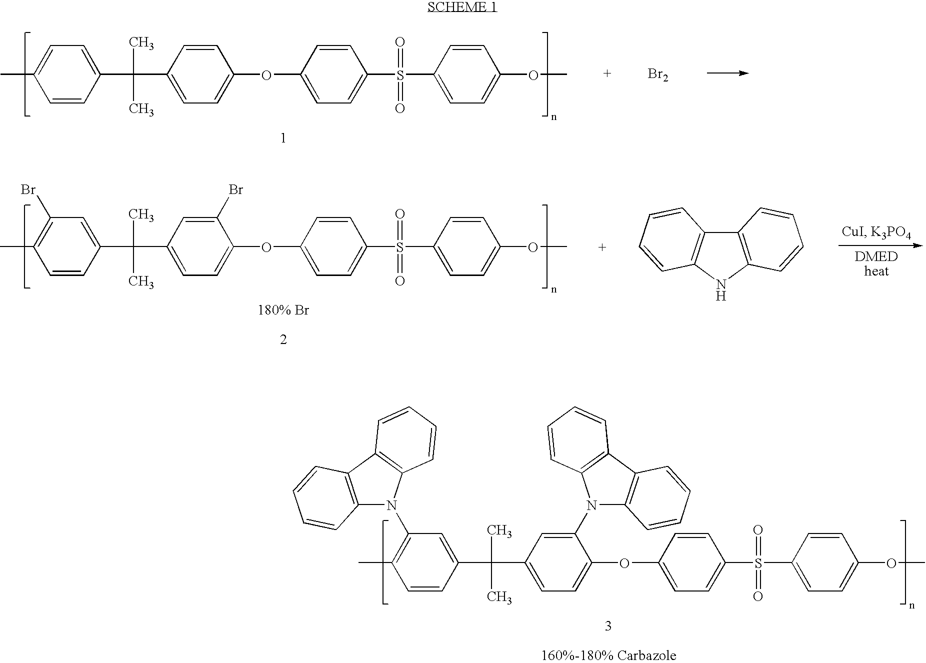

### EXAMPLE 1

### Bromination of Udel® Polysulfone

Udel® Polysulfone (60 grams) was dissolved in 300 milliliters (ml) of chloroform at room temperature. To this solution was added dropwise bromine (48 g) under a nitrogen atmosphere. The resulting dark red solution was stirred for 5 days. Methanol was added to the solution, and the resulting precipitate was collected and washed with methanol several times until an off-white color powder was obtained. The powder was dried to afford 80 g of a polymer identified as brominated Udel® by ¹H NMR. The weight average molecular weight (Mw) of the polymer was found to be 46,000, its polydispersity index PDI was 2.91, and the degree of bromination was estimated to be ˜180% per repeat unit based on ¹H NMR analysis.

### EXAMPLE 2

### Coupling of Brominated Polysulfone and Carbazole

To a reaction vial was added the brominated polysulfone of Example 1 (600 mg), carbazole (418 mg, 2.5 mmol), potassium phosphate (849 mg, 4.0 mmol), copper iodide (20 mg, 0.1 mmol) and dioxane 4 ml. The reaction flask was flushed with nitrogen, and then N,N′-dimethylethylenediamine (20 mg) was added. The reaction mixture was heated to 95° C. for 24 h. Subsequently, water was added to the solution, and the resulting precipitate was dried, and then redissolved in CHCl₃. The solution was filtered and re-precipitated in methanol. The solid was dried to afford polymer 3 (625 mg) identified as Udel® with pendant carbazole groups by ¹H NMR. The Mw of the polymer was found to be 26,000, its PDI was 3.12, and ¹H NMR spectroscopy showed complete substitution of bromine with carbazole units. The glass transition temperature (Tg) of the polysulfone having pendant carbazole groups was determined to be 205° C.

### EXAMPLE 3

### Triplet Energy Level Determination

General procedure: Triplet energy levels were obtained using a Perkin Elmer LS55 spectro-fluorimeter equipped with an uncooled R928 red sensitive photo multiplier tube. The typical procedure involved placing a sample in a clean laboratory mortar and immersing the sample in liquid nitrogen at least 2 minutes prior to the measurement to ensure thermal equilibrium. Then the sample was optically excited. Emission spectra were obtained by using the delayed collection feature of the LS55, in which the detection is gated at a time delayed from the initial 20 microsecond (μs) excitation pulse.

### Sample Preparation for Triplet Energy Level Determination:

Sample 1: Polymer 3 (10 mg) was dissolved in 1 ml anhydrous THF. The solution was then spin-coated onto a pre-cleaned quartz substrate.

Sample 2: A mixture of 1 weight percent (wt %) Ir(mppy)₃ in polystyrene (PS) was prepared by mixing of 0.010 ml of 1 wt % Ir(mppy)₃ (10 mg of Ir(mppy)₃ in 1 ml THF) with 1.0 ml of 1 wt % PS in THF.

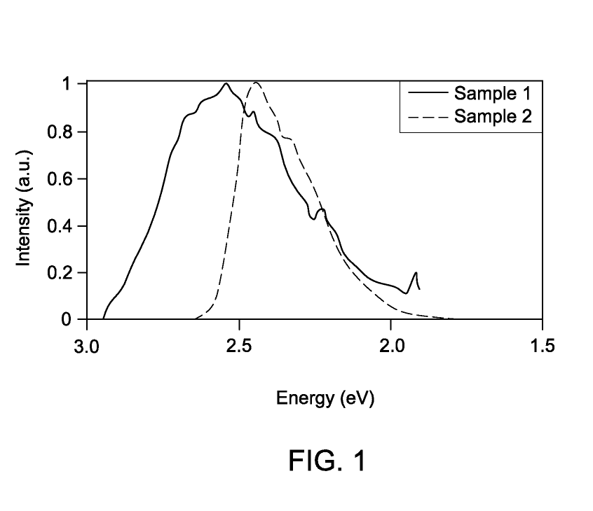

FIG. 1 shows that sample 1 has a greater triplet energy level relative to the sample 2. For instance, the first emission peak of sample 1 appears at 2.6 eV relative to the 2.4 eV for sample 2.

### EXAMPLE 4

### Device Fabrication and Characterization

An optoelectronic device was prepared in the following manner: Glass pre-coated with indium tin oxide (ITO) was used as the substrate. A layer (c.a. 65 nm) of PEDOT:PSS was deposited onto ultraviolet-ozone treated ITO substrates via spin-coating and then baked for 1 hour at 180° C. in air. A mixture solution of polymer 3:PBD:TPD:Ir(mppy)₃ (61:24:9:6 wt %) was prepared by mixing Polymer 3 (1.220 ml of a 1.5 wt % solution in chlorobenzene (CB)), PBD (0.240 ml of a 3.0 wt % solution in CB), TPD (0.090 ml of a 3.0 wt % solution in CB) and Ir(mppy)3 (0.18 ml of a 1 wt % solution in CB). Then the mixture solution was spin-coated onto the PEDOT:PSS and then baked at 70° C. for 10 mins. The device fabrication was finished with the deposition of a CsF (4 nm)/Al (100 nm) via thermal evaporation at a base pressure of 2×10⁻⁶ Torr. Following metal evaporation, the devices were encapsulated using a glass slide sealed with epoxy.

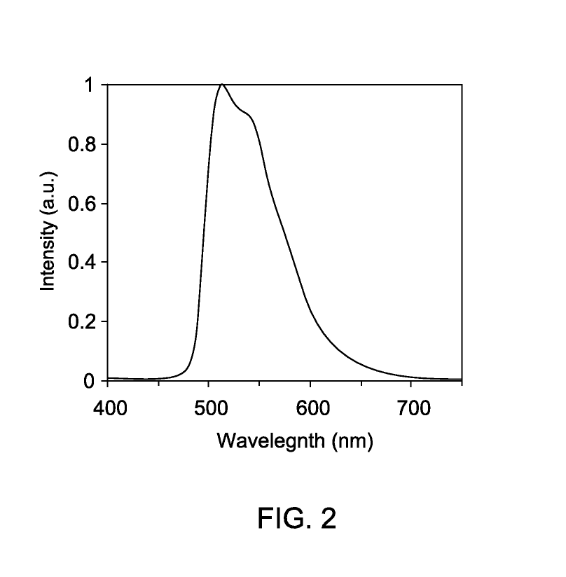

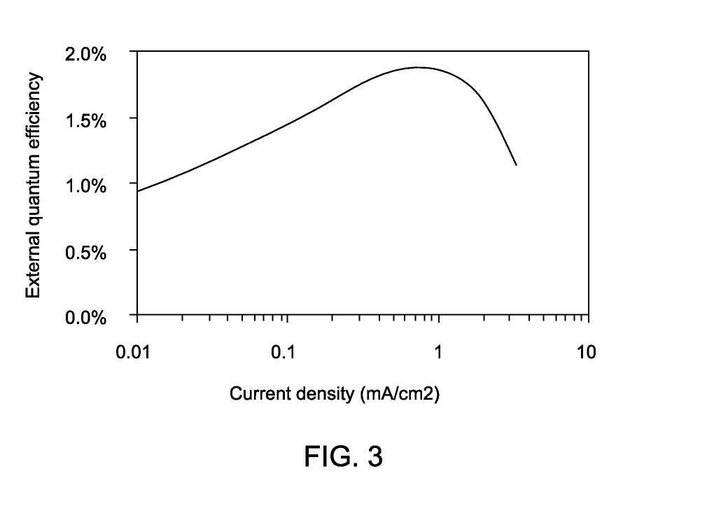

Performance of the device comprising the polymer of the invention was characterized by measuring current-voltage-luminance (I-V-L) characteristics. A photodiode calibrated with a luminance meter (Minolta LS-110) was used to measure the luminance of the device, in units of candela per square meter, cd/m². Upon bias, the device exhibits a green light characteristic for the Ir(mppy)₃ phosphorescent dye, as shown in FIG. 2. FIG. 3 shows that the device has a maximum external quantum efficiency (which is defined as the number of photons emitted out of the device per electron injected into the device) of 1.8%.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A polyarylether comprising structural units of formula I 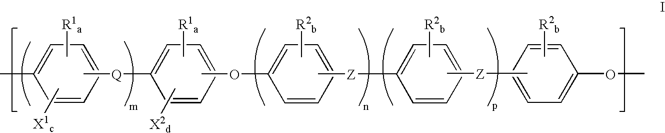
wherein
X¹ and X² are independently selected from Br, H, 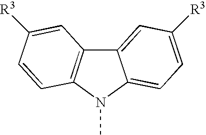
and combinations thereof;
R¹ and R² are independently at each occurrence H, halo, cyano, nitro, a C₁-C₁₂ aliphatic radical, a C₃-C₁₂ cycloaliphatic radical, a C₃-C₁₂ aromatic radical or a combination thereof;
R³ is hydrogen, triarylsilyl, trialkylsilyl, t-butyl, mesityl, diphenyl phosphine oxide, and diphenyl phosphine sulfide;
Q is a direct bond, O, S, alkenyl, alkynyl, a C₁-C₁₂ aliphatic radical, a C₃-C₁₂ cycloaliphatic radical, a C₃-C₁₂ aromatic radical or a combination thereof;
Z is a direct bond, O, S, SO, SO₂, CO, phenylphospinyl oxide, alkenyl, alkynyl, a C₁-C₁₂ aliphatic radical, a C₃-C₁₂ cycloaliphatic radical, a C₃-C₁₂ aromatic radical or a combination thereof;
a and b are independently 0, 1 or 2;
c and d independently range from about 0.5 to about 3;
m, n and p are independently 0 or 1; and
at least one of X¹ and X² is

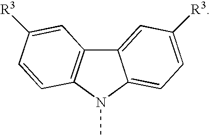

2. A polyarylether according to claim 1, wherein Q is C(CH₃)₂.

3. A polyarylether according to claim 1, wherein Z is SO₂.

4. A polyarylether according to claim 1, having structure

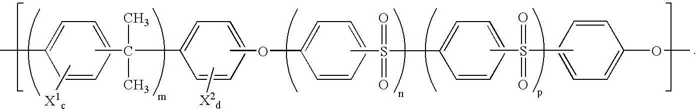

5. A polyarylether according to claim 1, wherein X¹ and X² are independently selected from H and

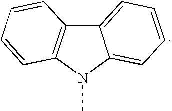

6. A polyarylether according to claim 1, additionally comprising structural units of formula

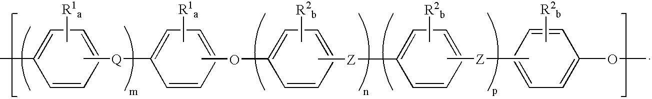

7. A polyarylether according to claim 6, wherein Q is C(CH₃)₂.

8. A polyarylether according to claim 6, wherein Z is SO₂.

9. A polyarylether according to claim 1, further comprising structural units of formula

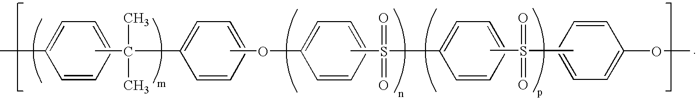

10. A polyarylether according to claim 1, further comprising structural units of formula

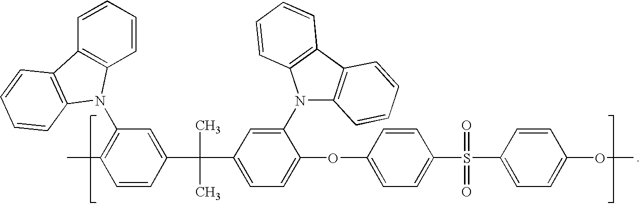

11. An optoelectronic device comprising
a polyarylether having structural units of formula I 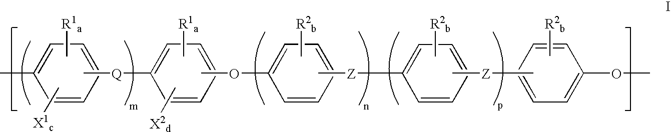
wherein
X¹ and X² are independently selected from Br, H, 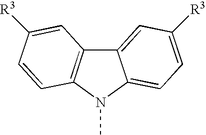
and combinations thereof;
R¹ and R² are independently at each occurrence H, halo, cyano, nitro, a C₁-C₁₂ aliphatic radical, a C₃-C₁₂ cycloaliphatic radical, a C₃-C₁₂ aromatic radical or a combination thereof;
R³ is hydrogen, triarylsilyl, trialkylsilyl, t-butyl, mesityl, diphenyl phosphine oxide, and diphenyl phosphine sulfide;
Q is a direct bond, O, S, alkenyl, alkynyl, a C₁-C₁₂ aliphatic radical, a C₃-C₁₂ cycloaliphatic radical, a C₃-C₁₂ aromatic radical or a combination thereof;
Z is a direct bond, O, S, SO, SO₂, CO, phenylphospinyl oxide, alkenyl, alkynyl, a C₁-C₁₂ aliphatic radical, a C₃-C₁₂ cycloaliphatic radical, a C₃-C₁₂ aromatic radical or a combination thereof;
a and b are independently 0, 1 or 2;
c and d independently range from about 0.5 to about 3;
m, n and p are independently 0 or 1; and
at least one of X¹ and X² is

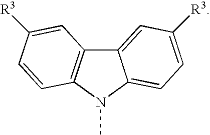

12. An optoelectronic device according to claim 11, wherein Q is C(CH₃)₂.

13. An optoelectronic device according to claim 11, wherein Z is SO₂.

14. An optoelectronic device according to claim 11, comprising a polyarylether having structure

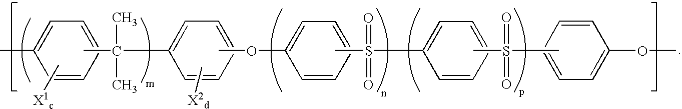

15. An optoelectronic device according to claim 11, wherein X¹ and X² are independently selected from H and

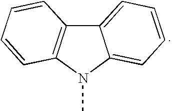

16. An optoelectronic device according to claim 11, wherein the polyarylether additionally comprises structural units of formula

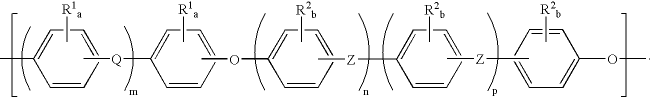

17. An optoelectronic device according to claim 16, wherein Q is C(CH₃)₂.

18. An optoelectronic device according to claim 16, wherein Z is SO₂.

19. An optoelectronic device according to claim 11, wherein the polyarylether further comprises structural units of formula

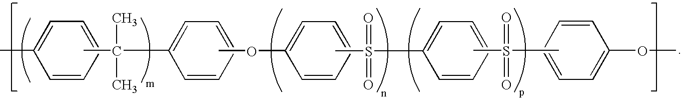

20. An optoelectronic device according to claim 11, wherein the polarylether further comprises structural units of formula [chemical structure]
